(19) United States
(12) Patent Application Publication
(10) Pub. No.: US 2011/0104574 A1
(43) Pub. Date: May 5, 2011

(54) Nonaqueous electrolyte for lithium Ion and lithium metal batteries

(75) Inventors: Elena M. Shembel, Colar Springs, FL (US); Irina Maksyuta, Dnepropetrovsk (UA); Volodymyr Redko, Coral Springs, FL (US); Tymofiy V. Pastushkin, Ft. Lauderdale, FL (US)

(73) Assignee: Enerize Corporation, Coral Springs, FL (US)

(21) Appl. No.: 12/803,952

(22) Filed: Jul. 8, 2010

Related U.S. Application Data
(60) Provisional application No. 61/271,048, filed on Jul. 16, 2009.

(51) Int. Cl. H01M 10/0562; H01M 10/0565

(52) U.S. Cl. 429/310; 429/322; 429/313

(57) ABSTRACT

Nonaqueous electrolyte for high energy Li-ion batteries or batteries with lithium metal anode, in which the composition of additives are introduced to increase specific characteristics of lithium batteries including stability of the parameters during cycling and security of the battery operations, when the composition of the additives comprises the compounds from the class of esters, low molecular weight silicon quaternary ammonium salts, and macromolecular polymer organosilicon quaternary ammonium salts.

### CROSS-REFERENCE TO RELATED APPLICATIONS

This application incorporated by reference in its entirety and claims priority to Provisional Application No. 61/271,048, Filed Jul. 16, 2009.

### FEDERALLY SPONSORED RESEARCH

None

### SEQUENCE LISTING

None

### FIELD OF THE INVENTION

The invention relates to the area of high energy secondary and primary lithium batteries, more specifically to non-aqueous liquid and polymer electrolytes, in which additives are introduced to enhance specific characteristics of lithium batteries including the stability of the parameters during cycling and security of the battery operations.

### BACKGROUND

The purpose of this invention is to increase specific characteristics and stability of the battery during cycling, prevent gas formation in the process of battery charge, and increase reliability and safety of lithium-ion secondary batteries.

The purpose of the invention is also to increase specific characteristics and reliability of primary power sources based on lithium metal or lithium alloy as anode and oxides, and sulfur-containing or fluorine-containing compounds as cathode.

This objective is achieved thanks to introducing modifying and stabilizing additives in non-aqueous electrolyte. These additives act in several directions. Additives increase electrochemical and chemical stability of the electrolyte in a wide range of potentials, i.e. decrease the rate of oxidation and reduction components of non-aqueous electrolyte. One mechanism for this effect is to increase the over voltage of electrochemical decomposition reactions of the electrolyte as a result of the adsorption of the additives on the surface of the electrode.

The following mechanism of the effect of additives is connected with the fact that the additives modify the passivating film on the surface of the cathode and anode. As a result, the rate of electrochemical reaction of intercalation and deintercalation of lithium ions to the solid phase of the electrodes is increased. Effect of the additives can also be seen in the fact that they form complexes with the cations of alkali metals, in this case with the lithium cations. Such complexes have higher mobility in nonaqueous electrolyte. As a result, the possible diffusion limitations at the interface of the electrode-electrolyte are decreased.

At the same time, the additives must meet special requirements in the terms of the electrochemical and chemical stability over a wide range of potentials and temperatures.

### BRIEF DESCRIPTION OF THE INVENTION

In the presented invention the problem that is posed is solved by using complex of the additives which are introduced into the non-aqueous liquid or non-aqueous polymer electrolyte of lithium battery.

In the present invention the composition of additives on the basis of the following composition is used:

1. The compounds of the class of esters,
2. Low molecular weight silicon quaternary ammonium salt, and
3. Macromolecular high weight polymer organosilicon quaternary ammonium salts

### DESCRIPTION OF THE DRAWINGS

FIG. 1 represents potentiodynamic background characteristics of the electrolyte EC, DMC, LiPF₆ without additive. The working electrode was Pt. Operating range of the potential was 3.0 V-4.0 V. 101 corresponds to cycle No. 1, 102 corresponds to the cycle No. 2

FIG. 2 represents potentiodynamic background characteristics of the electrolyte EC, DMC, LiPF₆ without additive. The working electrode was Pt. Operating range of the potential was as follow: a) 3.0 V-4.2 V; b) 3.0 V-4.5 V; c) 3.0 V-4.7 V; d) 3.0 V-5.0 V

FIG. 3a represents comparison of the I-U background characteristics in EC, DMC, LiPF₆ electrolytes with additive (303, 304) and without additive (301, 302). The following mixture was used as additive: 90% of the crown ethers (12-CROWN ether-4)+5% low molecular weight silicon quaternary ammonium salts +5% macromolecular (high weight) polymer organosilicon quaternary ammonium salts (organosilicone polyviologen). V=10 mB/s. First cycle: 301, 303; second cycle: 302, 304

FIG. 3b represents comparison of the I-U background characteristics in EC, DMC, LiPF₆ electrolytes with additives. The following mixture was used as additive: 90% of the crown ethers (12-CROWN ether-4)+5% low molecular weight silicon quaternary ammonium salts +5% macromolecular (high weight) polymer organosilicon quaternary ammonium salts (organosilicone polyviologen). V=10 mB/s Operating range of the voltage: (305) 3.0 V-5.5 V; (306) 3.0 V-4.5 V.

FIGS. 4a and 4b represent the I-U background characteristics in EC, DMC, LiPF₆ electrolytes with additive. The following mixture was used as additive: 90% of the crown ethers (12-CROWN ether-4)+5% low molecular weight silicon quaternary ammonium salts +5% macromolecular (high weight) polymer organosilicon quaternary ammonium salts (organosilicone polyviologen). V=10 mB/s. Operating range of voltage: a) 3.0 V-4.7 V; b) 3.0 V-5.0 V

FIG. 5 represents the potentiodynamic cycling characteristics of the cathode based on LiMn₂O₄ in electrolyte EC, DMC, and LiPF₆ without additive. Electrode No. 11. Operating range of the potential was 3.0 V-4.3 V. Number of cycle: a) 1-9; b) 11-26

FIG. 6a and FIG. 6b represent the potentiodynamic cycling characteristics of the cathode based on LiMn₂O₄ in electrolyte EC, DMC, LiPF₆ with additive. Electrode No. 10. Operating range of the potential was 3.0 V-4.3 V. Mass of LiMn₂O₄ was 0.0027 g. Number of cycles: a) 1-5; b) 6-10; c) 23-28. The following mixture was used as additive: 90% of the crown ethers (12-CROWN ether-4)+5% low molecular weight silicon quaternary ammonium salts +5% macromolecular (high weight) polymer organosilicon quaternary ammonium salts (organosilicone polyviologen). V=10 mB/s

FIG. 7 represents the potentiodynamic cycling characteristics of the cathode based on LiMn₂O₄ in the coordinates of the current-time. Electrolyte: EC, DMC, LiPF₆ with additives. Operating range of the potential during cycling was 3.0 V-4.3 V. Electrode No. 10. Number of cycles: 23-28

FIG. 8 represents the value of the discharge capacity of the LiMn₂O₄ electrode during cycling in electrolyte EC, DMC, LiPF₆ with additive. The following mixture was used as additives: 90% of the crown ethers (12-CROWN ether-4)+5% low molecular weight silicon quaternary ammonium salts +5% macromolecular (high weight) polymer organosilicon quaternary ammonium salts (organosilicone polyviologen). V=10 mB/s

FIG. 9 represents the dependence of discharge capacity of LiMn₂O₄ electrode on cycle number during the potentiodynamic cycling. Electrolyte was EC, DMC, and LiPF₆. Results for samples with additives (902) and without additives (901) are presented. The following mixture was used as additive: 90% of the crown ethers (12-CROWN ether-4)+5% low molecular weight silicon quaternary ammonium salts +5% macromolecular (high weight) polymer organosilicon quaternary ammonium salts (organosilicon polyviologen). V=10 mB/s

FIG. 10 represents charge-discharge characteristics of the coin cell Li—LiMn₂O₄, Electrode No. 1702, I ch=I dch=1 C. Electrolyte EC, DMC, LiPF₄ without the additives. Mass of LiMn₂O₄: 0.023 g. Numbers on curves correspond to the number of cycles.

FIG. 11 represents charge-discharge characteristics of the coin cell Li—LiMn₂O₄, Electrode No. 1703 LiMn₂O₄. I ch=I dch=1 C. Electrolyte EC, DMC, LiPF₄ with additives. Mass of LiMn₂O₄: 0.024 g. The following mixture was used as additive: 90% of the crown ethers (12-CROWN ether-4)+5% low molecular weight silicon quaternary ammonium salts +5% macromolecular (high weight) polymer organosilicon quaternary ammonium salts (organosilicone polyviologen). V=10 mB/s. Numbers on curves correspond to the number of cycles.

FIG. 12 represents the comparison of the charge-discharge characteristics of the coin cell Li—LiMn₂O₄. 1202—electrolyte with additive; 1201—electrolyte without additive. I_{ch}=I_{dch}=1 C. Cycle No. 8

FIG. 13 represents the comparison of the change the discharge capacity of the coin cells Li—LiMn₂O₄ in the case of the electrolyte with additive according to the presented invention (1302) and electrolyte without additive (1301)

FIG. 14 represents the effect of the stabilizing additives in nonaqueous electrolyte PC, DME, LiClO₄ during the charge process. Changes of the electrode voltage and the volume of gas that is formed during the charge process are presented.

### DETAILED DESCRIPTION OF THE INVENTION

With the goal to increase stability of the Li-ion battery during cycling and to provide the high level of cyclability the special compositions of modifying additives to electrolyte were developed in accordance with the present invention.

1. One example of compounds from the class of esters, which are used in the claimed invention is the crown ethers with the formula 12-crown-4.

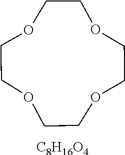

This compound corresponds to the formula C₈H₁₆O₄. Molecular weight is 176.212.

This compound is also known as: 1, 4, 7, 10-Tetraoxacyclododecane

2. The low molecular weight organosilicon quaternary ammonium salt is second component of the composition of the additives. These types of the compounds have in its structure the following group:

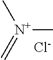

Such compounds can be obtained as a result of interaction of the bis (chloromethyl) dimethylsilyl ether pentaethylene glycol with 4,4′-dipyridyl in accordance with the following reaction:

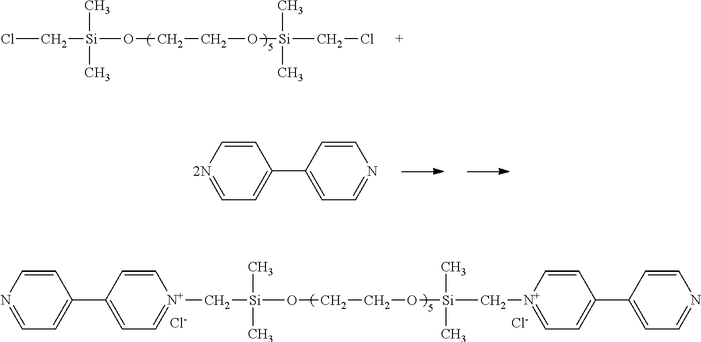

3. Macromolecular polymer organosilicon quaternary ammonium salts belong to the class of the high-molecular weight polymer quaternary ammonium salts and have the structure that is presented below:

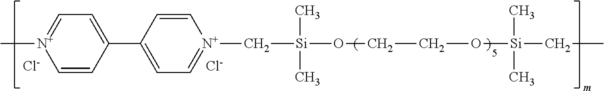

where “m” characterizes the degree of the polymerization.

Example 1 presents the example of the synthesis of the low molecular weight organosilicon quaternary ammonium salt.

Example 2 presents the example of the synthesis of the macromolecular polymer organosilicon quaternary ammonium salts. These type of the salts is also known as organosilicone polyviologen.

Electrochemical properties of the non aqueous electrolytes in which the composition of the additives was added, and the electrochemical properties of the non aqueous electrolytes without the composition of the additives have been investigated under different regimes. These electrochemical characteristics are presented below.

Results of the investigations and testing which are presented below confirm the positive effect of the composition of modifying additive that allows to increase the stability of the Li-ion cell parameters during cycling.

Information presented below includes:
characterization data and description of the methods of testing
description of the process of preparing liquid electrolyte with additives in accordance with the presented invention
description of the process of preparing cathode based on spinel LiMn₂O₄
test results of the effect of additives to electrolyte for improving cyclability of the Li-ion batteries.

The following methods of testing were used:
potentiodynamic background characteristics of the electrolyte with additives and without additives when the platinum electrode was used as a working electrode.
potentiodynamic characteristics of the electrodes based on LiMn₂O₄ under wide operating range of the rate of potential sweep when using the electrolyte with the additives and the electrolyte without the additives;
galvanostatic characteristics of the electrode based on LiMn₂O₄ in electrolyte with additives and in electrolyte without additives;
investigation of the effect of the additives on the electrochemical process on the cathode based on LiMn₂O₄ in two electrodes coin cells Li—LiMn₂O₄. Galvanostatic cycling mode.

### Description of the Methods of the Testing

The noneaqueous electrolyte with composition DMC, EC (1:1)+1M LiPF₆ was used for testing. For the nonaqueous electrolyte the following materials have been used: EC, DMC—from Merck, Germany; LiPF₆—from Advance Research Chemical, USA.

The concentration of the additives composition in electrolyte was, for example, equal to 5×10⁻² mass. %. In this case during the research of the initial solution of the additives composition in electrolyte EC, DMC (1:1), 1M LiPF₆ in concentration 5×10¹ mass. % has been prepared. The liquid electrolyte with the additives composition was extra dried over molecular sieve NaA within 7 days to remove traces of water from the electrolyte. The molecular sieves before the introduction in the electrolyte were annealed at 500° C. during 5 hours.

After this stage the quantity of such “concentrated electrolyte” that was calculated was introduced into the bulk of the electrolyte. The final concentration of the additive in electrolyte in accordance with shown above was 5×10⁻² mass. %.

In details, the preparation of the electrolytes with additives is as follows:
The concentration of additive in electrolyte must be 5×10⁻² mass %. It means that in 100 g of electrolyte there must be 0.05 g of the additive.
For preparing the electrolyte with additives we did the following:
   Prepare the initial electrolyte with the concentration of additive 5×10⁻¹ mass %. It means that in 100 g of the initial electrolyte there was 0.5 g of additive;
   Prepare the working electrolyte with the concentration of additive 5×10⁻²%. For preparation of the working electrolyte the initial electrolyte was diluted tenfold. For example to 10 g of the initial electrolyte with 0.05 g of the additives 90 g of the electrolyte without additives has been added. As a result, in 100 g of electrolyte there was 0.05 g of additives. The concentration of additives in the working electrolyte was 5×10⁻² mass %;
   In other words, in 1 g of working electrolyte the quantity of the additive must be the 0.0005 g.

One drop of additives from a syringe of 5 ml has a weight of 10 mg.

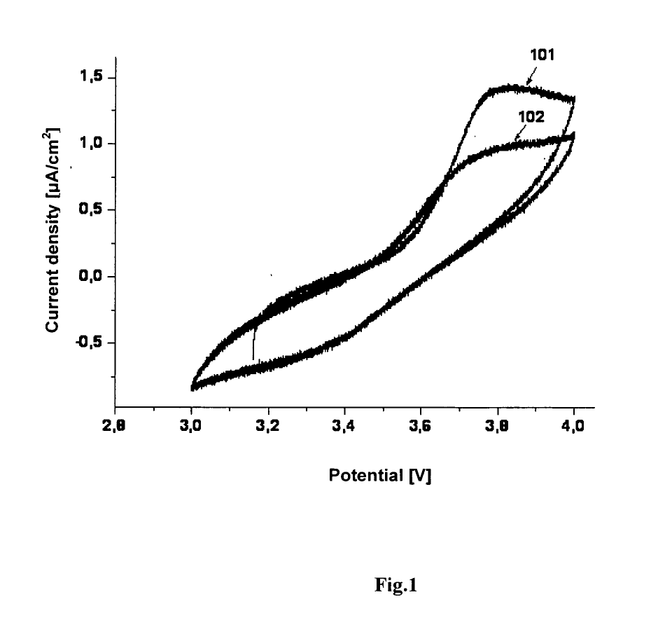

The potentiodynamic background characteristics of the electrolyte are shown on FIG. 1, 2, 3a, 3b, 4. The electrochemical potentiodynamic investigations of the effect of the additives on the electrochemical stability of non aqueous electrolytes were conducted using Pt electrode as a working electrode. Electrochemical potentiodynamic investigations were conducted in a three electrode cell made by Teflon. The end of platinum wire with the diameter 1 mm (area 0.0079 cm²) was served as a working electrode area. The scan and the curves registration was performed on the universal device Voltalab-40. Speed scanning capabilities was 10 mV/s.

Electrochemical potentiodynamic investigations of the cathode have been conducted in a three electrodes cell made by Teflon. As a working electrode, the cathode based on spinel LiMn₂O₄ was used. Comparison and auxiliary electrodes were made of lithium. The cathode surface was 0.2 cm². Cyclic curves were taken in the operating range of potential from 3 to 4.3 V. Cycling was carried with interruption after discharge. (after 5 or after 19 cycles). The scanning speed of the potential was 0.5 mV/sec. In terms of <<C>> the rate of the discharge-charge processes was 1.38 C.

Charging and discharging capacity was calculated by integrating the I-U curves. All electrochemical investigations with three electrode cells have been conducted in a dry argon box.

Galvanostatic cycling of the system Li—LiMn₂O₄ has been conducted in a coin cell 2325 with two electrodes: cathode based on the spinel LiMn₂O₄ and Li anode. The surface of the cathode was 2.5 cm². Description of the composition of the cathode mass based on the spinel LiMn₂O₄ is presented below.

Electrochemical galvanostatic cycling tests were carried out in an automatic booth with a computer recording and processing of experimental data. Cycling was carried out in the range of potentials 3.0 V÷4.3 V. The rate of the charge-discharge varied in the range from 0.5 C to 1 C

The composition of the cathode mass was as follows:
LiMn₂O₄, 85 mass %. Before using the spinel LiMn₂O₄ was annealed under 300° C. during 4.5-5 hours.
Acetylene black, 5 mass %
Graphite EUZM, 5 mass %
Binder, suspension of Teflon, 5 mass %

The stainless steel mesh was used as a current collector for cathode. After coating on the electrode mass on the stainless steel mesh the electrode was dried under 250° C. during 5 hours.

The lithium serves as an auxiliary electrode, was pressed to the stainless mesh that is welded to the cover of the coin cell. The fiberglass with thickness 100 microns was used as a separator.

Results of the investigation of the effect of the additives on the electrochemical stability of the electrolyte EC, DMC (1:1), 1M LiPF₆ are presented below.

To assess the impact of the additive in accordance with the presented invention on the electrochemical stability of the nonaqueous electrolyte, the comparison of the potentiodynamic background characteristics on the platinum electrode for the electrolyte with additive in accordance with the presented invention and without additives has been conducted.

The potentiodynamic background characteristics of the electrolyte without additive are described below.

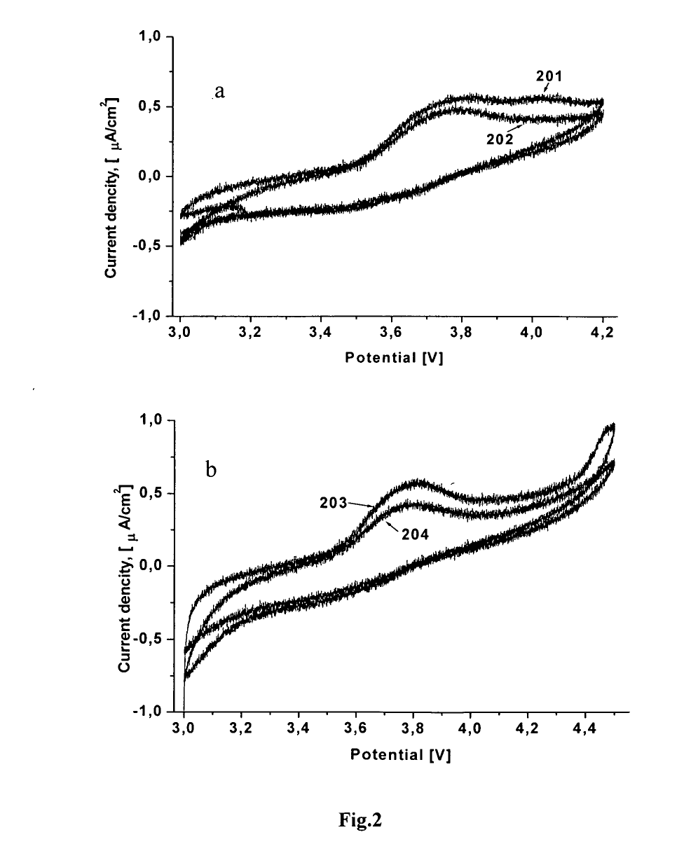

FIGS. 1 and 2 represent the potentiodynamic background characteristics of the electrolyte EC, DMC, LiPF₆. The potentiodynamic curves were investigated sequentially in the operating range of voltage as follows: 3.0-4.0 V; 3.0-4.2 V; 3.0-4.5 V; 3.0-4.7 V, and 3.0-5.0 V. The Pt was as working electrode.

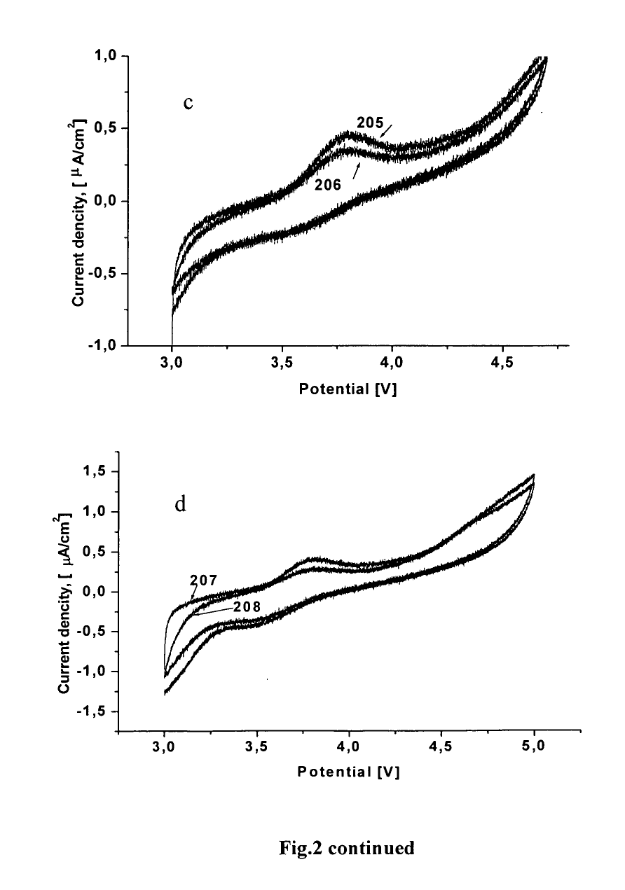

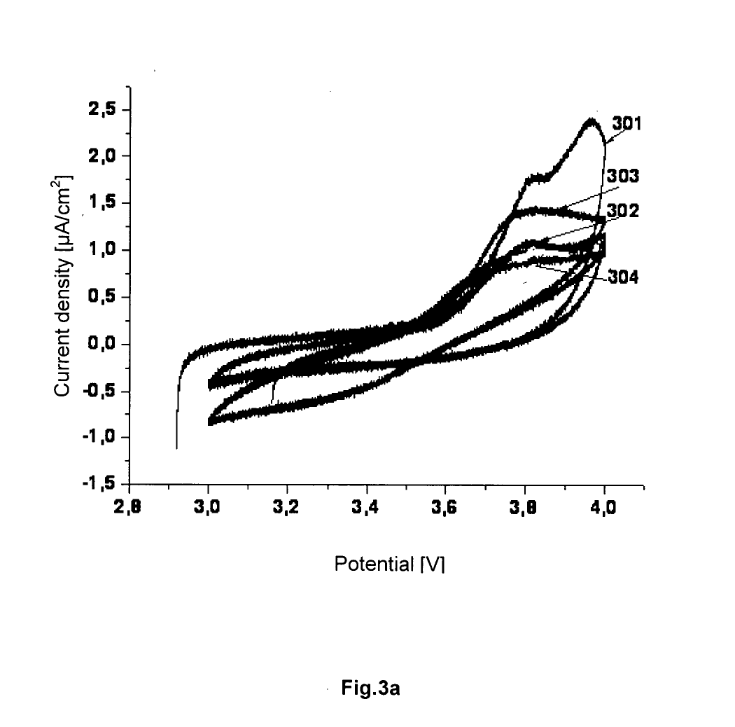

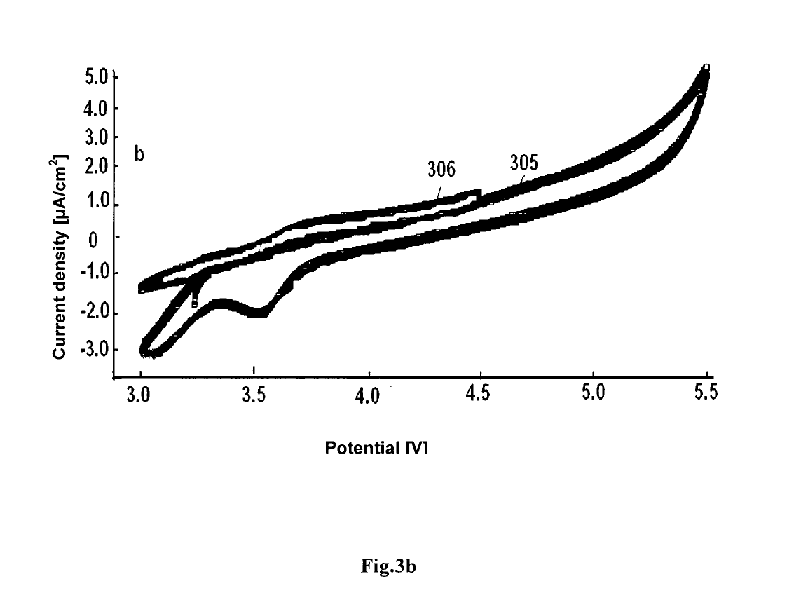

The potentiodynamic background characteristics of the electrolyte with additives are presented on the FIG. 3 a, and FIG. 3 b and are described below. In FIGS. 3a and 3b the I-U characteristics in EC, DMC, LiPF₆ electrolytes without additive (301, 302) and with additive (303, 304, 305, and 306) are compared. Apparently, the introduction of additive in the electrolyte reduces the value of anodic peak at E=3.8 V. For each electrolyte the first and second cycles are presented. Operation ranges of the potentials are shown of the FIGS. 3a and 3b.

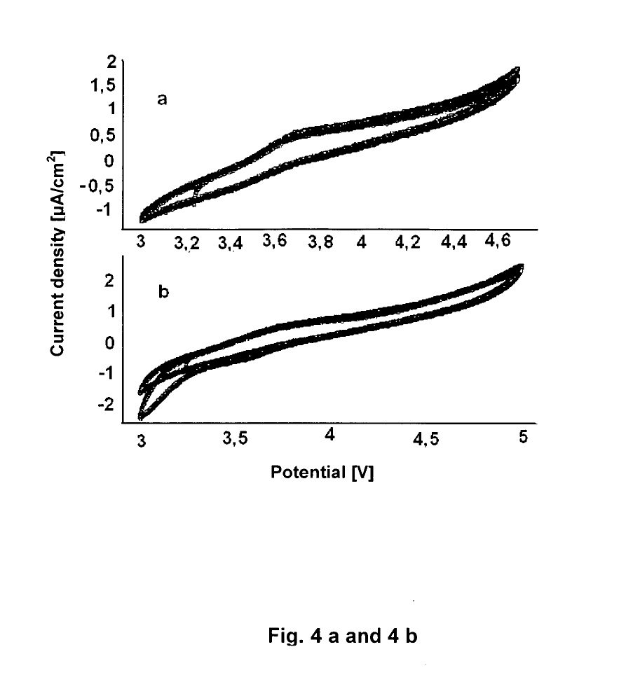

On FIG. 4 the I-U background characteristics in EC, DMC, LiPF₆ electrolytes with additives are presented. Operating range of the potential in anodic area was increased up to 5.0 V. Side processes do not appear in the electrolyte with additives.

Investigation the effect of the additives on the electrochemical process on the cathode in electrolyte EC, DMC (1:1), 1M LiPF₆ was conducted using potentiodynamic cycling. Description of the potentiodynamic characteristics of the cathode based on LiMn₂O₄ in electrolyte without additives is presented below.

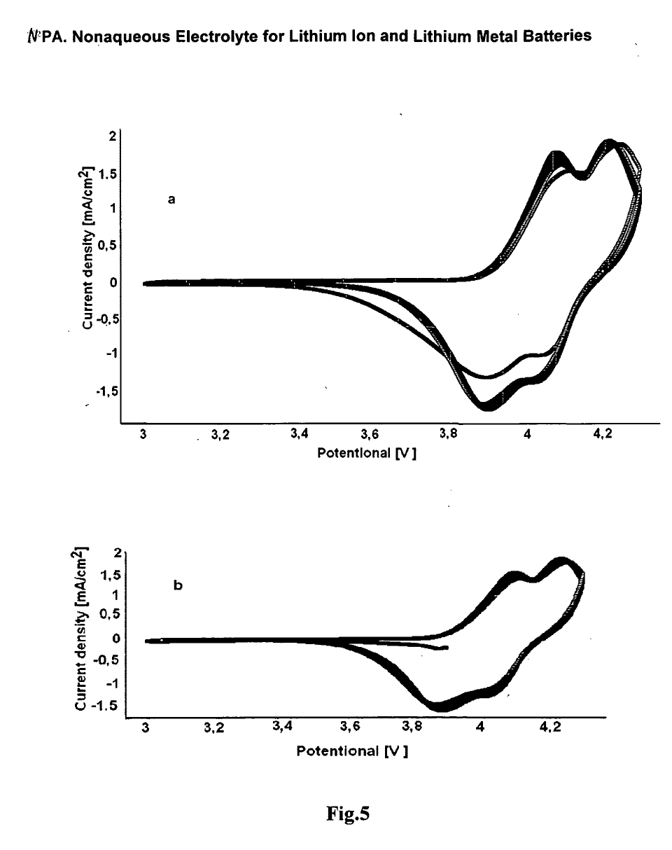

On the FIG. 5 results of the investigation the electrochemical characteristics of the cathodes No. 11 (FIG. 5a) and No. 17 (FIG. 5b) based on the LiMn₂O₄ in electrolyte EC, DMC, LiPF₆ are presented. The method of the potentiodynamic cycling in a three electrode cell was used. The value of the LiMn₂O₄ was for electrode No. 11-0.0031 g and for electrode No. 17-0.0040 g. Results which are presented here indicate that in the electrolyte without the additives the decreasing of the reversible discharge capacity during charge-discharge testing is more noticeable as compared to electrolyte with the additives.

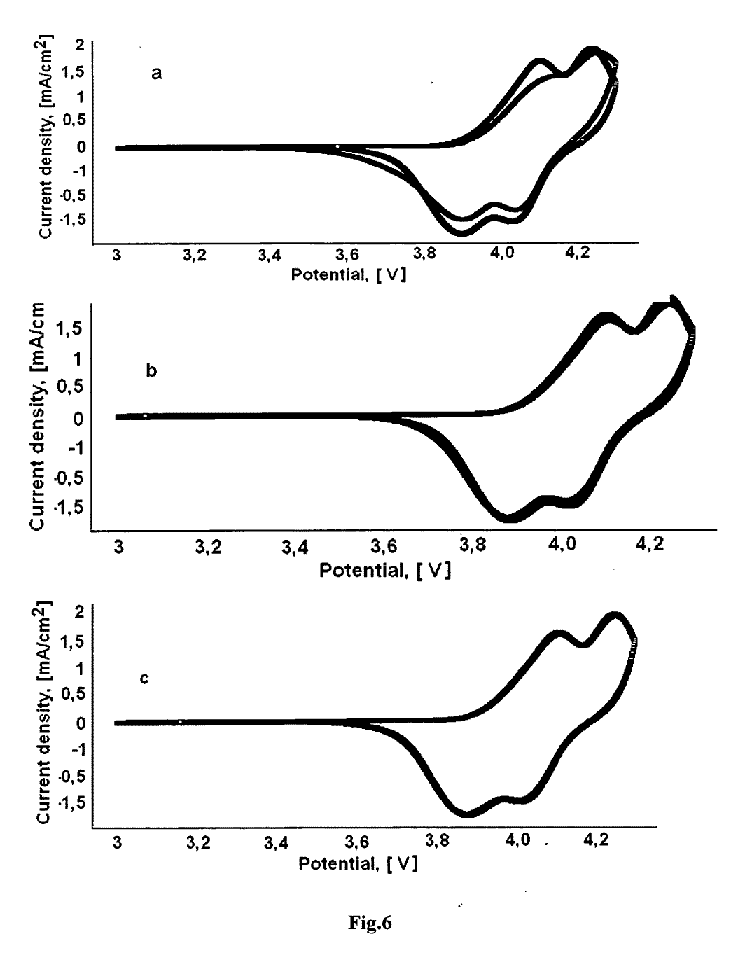

The potentiodynamic characteristics of the cathode based on LiMn₂O₄ in electrolyte with additives are described below. In FIG. 6 the potentiodynamic curves of the LiMn₂O₄ electrode at different cycles are presented. Presented results indicate the high stability of cycling and the stability of the cathode reversible capacity through LiMn₂O₄. (electrode No. 10) The discharge capacity on the different cycle shown below: For the cycle No. 1 the discharge capacity is 108.35 mAh/g; For the cycle No. 2 the discharge capacity is 113.77 mAh/g; For the cycle No. 5 the discharge capacity is 113.66 mAh/g; For the cycle No. 10 the discharge capacity is 113.77 mAh/g; For the cycle No. 25 the discharge capacity is 112.48 mAh/g

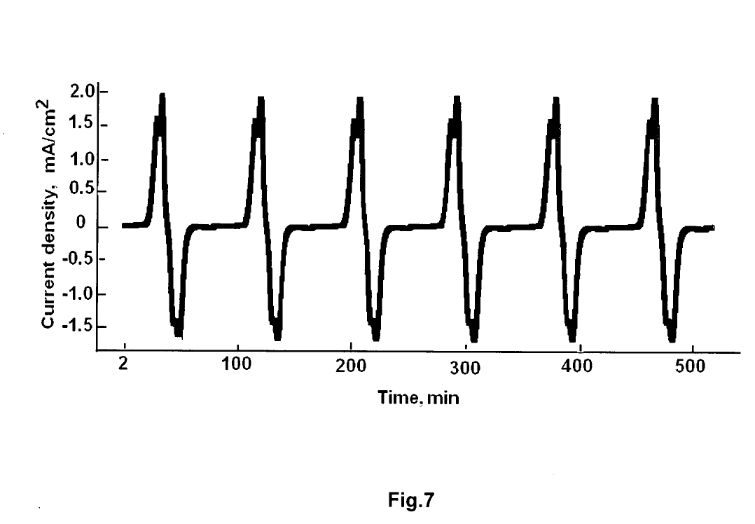

Potentiodynamic cycling characteristics which are presented in the coordinates of Current-Time are shown in the FIG. 7. Electrolyte: EC, DMC, LiPF₆ with additive has been used. Operating range of the potential during cycling was 3.0 V-4.3 V. Electrode No. 10 was based on LiMn₂O₄. Number of cycles: 23-28. Results confirm the high level of stability of the cycling in electrolyte with additives.

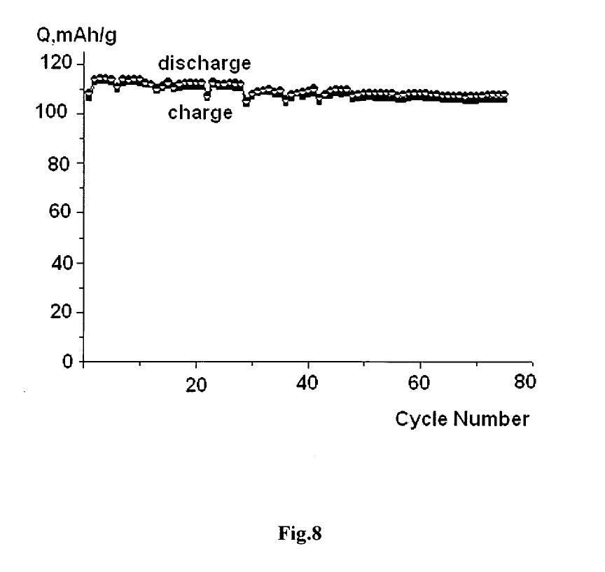

The value of the discharge capacity of LiMn₂O₄ electrode during cycling in electrolyte EC, DMC, LiPF₆ with the additives is presented on FIG. 8. On FIG. 8 the dynamics of the change of the discharge capacity of the electrode No. 10 during the potentiodynamic cycling in electrolyte with the additives is shown. Speed scanning of the potential was 0.5 mV/sec. The duration of one cycle of charge-discharge was 1.44 hour. In terms of <<C>> the rate of discharge-charge was 1.38 C. Results presented here indicate that in the case of electrolyte with the additives the discharge capacity of LiMn₂O₄ during potentiodynamic cycling is stable.

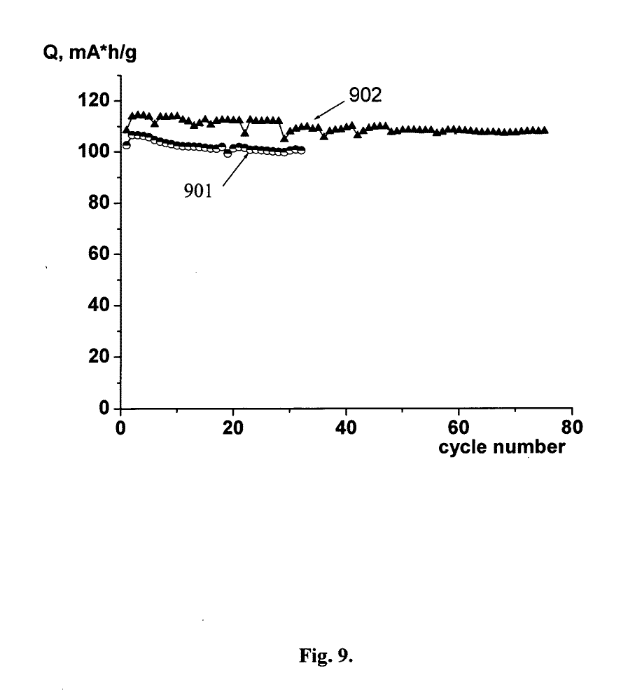

In FIG. 9 the data on change of the specific discharge capacity of LiMn₂O₄ electrode No. 11 and No. 17 during potentiodynamic cycling in the electrolyte without additives (901) and electrode No. 10 in the electrolyte with additives (902) are compared. They show the dependence of discharge capacity of LiMn₂O₄ electrode on cycle number that is calculated based on the results of potentiodynamic cycling in the cell with electrolyte EC, DMC, LiPF₆. Cycling results confirm that the additives allow to increase stability of the parameters of the electrode during cycling.

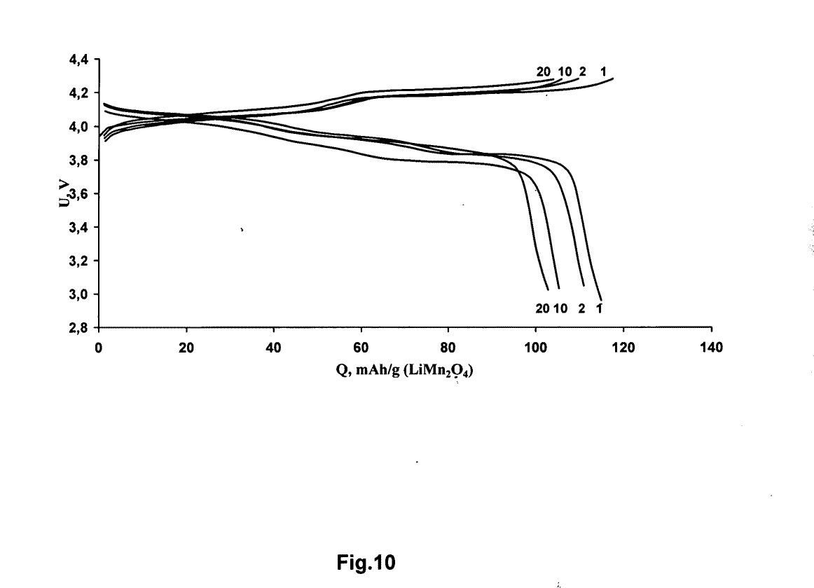

Investigations of the effect of the additive on the electrochemical process of the cathode in electrolyte EC, DMC (1:1), 1M LiPF₆ were conducted in galvanostatic cycling mode of two electrodes coin cells: Li—LiMn₂O₄. On FIG. 10 the results of galvanostatic cycling of the coin cell Li—LiMn₂O₄ with electrolyte EC, DMC, LiPF₄ without the additives are presented.

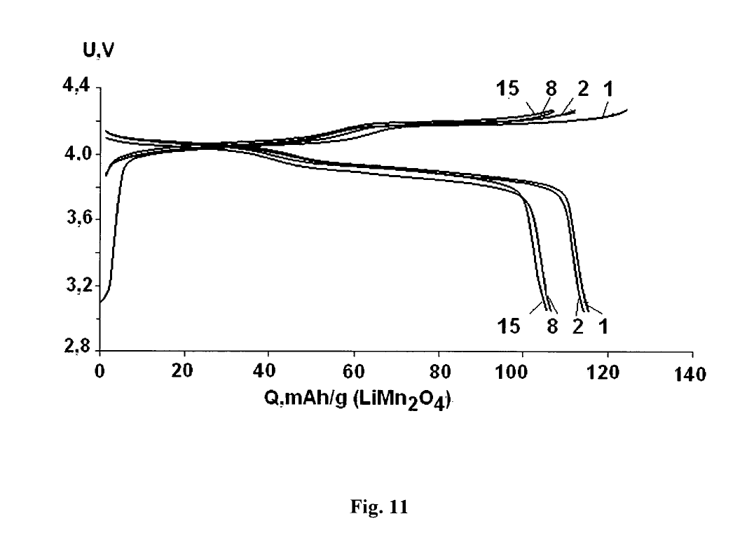

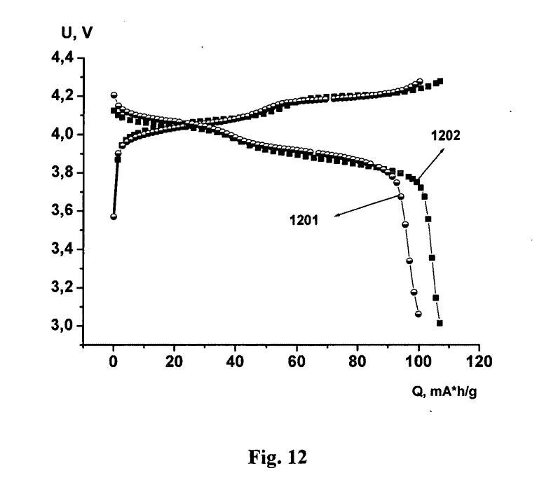

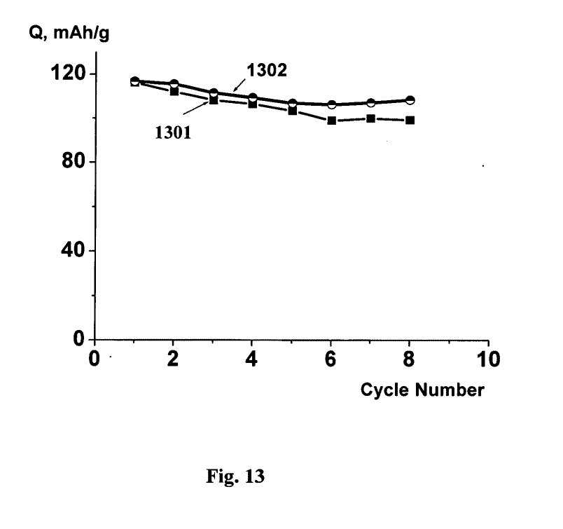

Additional test results of the coin cell Li—LiMn₂O₄ that are presented on the FIGS. 11, 12 and 13 confirm the positive effect of the modifying additive that allows to increase stability of the Li-ion cell parameters during cycling.

Invention presents results of the development and testing of the additives for increasing stability during the storage and cycling, for example, Li-ion battery with the cathode based on LiMn₂O₄—spinel. Stability of the cathode during cycling depends on the electrolyte stability during the charge process. Thus the results of the Li-ion battery cycling confirm that the special additives which ensure the increasing of stability of the electrolyte during storage and cycling have been developed. Additives that are used in accordance with the presented invention enhance the electrochemical stability of non-aqueous electrolytes during battery charge. As a result, the cyclability of Li-ion batteries increases.

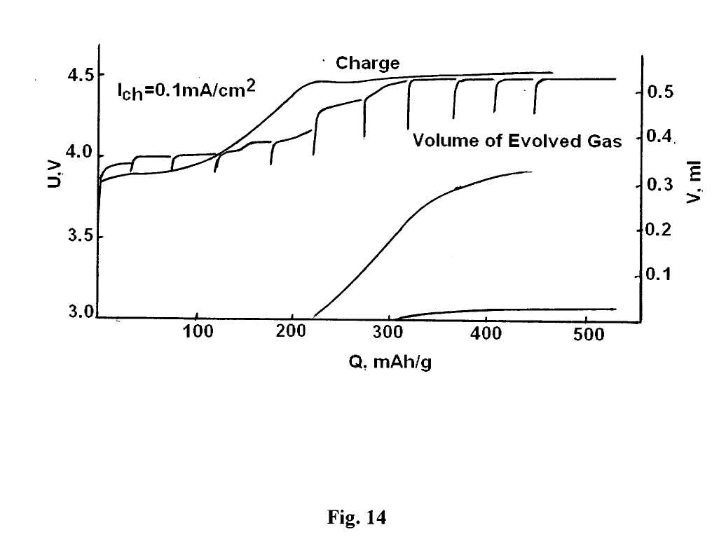

In FIG. 14 we show how additives can increase stability of the electrochemical process in a Li-ion systems due to decrease of the destruction of the electrolyte and decrease of the gas formation due to electrolyte decomposition. It illustrates the effect of stabilizing additives in nonaqueous electrolyte PC, DME, LiClO₄ during the charge process. The change of voltage and volume of the gas which is formed are presented on the FIG. 14.

Results of the presented investigation and tests confirm positive effect of the modifying additives which allow to increase stability of the electrolyte and the parameters of the Li-ion battery during the cycling.

### EXAMPLES

The Examples described below are provided for illustration purposes only and are not intended to limit the scope of the invention.

### Example 1

This example describes the synthesis of low molecular weight organosilicon quaternary ammonium salts which are used in the composition of additives in accordance with the present invention.

### 1 Step

On the first step of the synthesis the bis (chloromethyl) dimethylsilyl ether pentaethylene glycol is obtained:

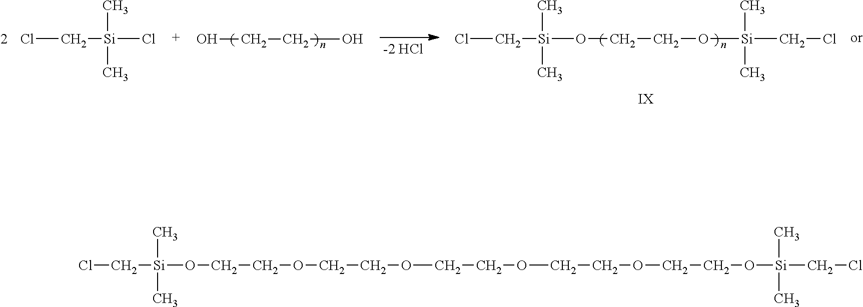

Molecular Weight=451.54
Exact Mass=450
Molecular Formula=C16H36Cl2O6Si2
Molecular Composition=C, 42.56%; H, 8.04%; Cl, 15.70%; O, 21.26%; Si, 12.44%.

### 2 Step

On the second step the low molecular weight organosilicon quaternary ammonium salts is obtained as a result of interaction bis (chloromethyl) dimethylsilyl ether pentaethylene glycol with 4,4′-dipyridyl in accordance with the following reaction:

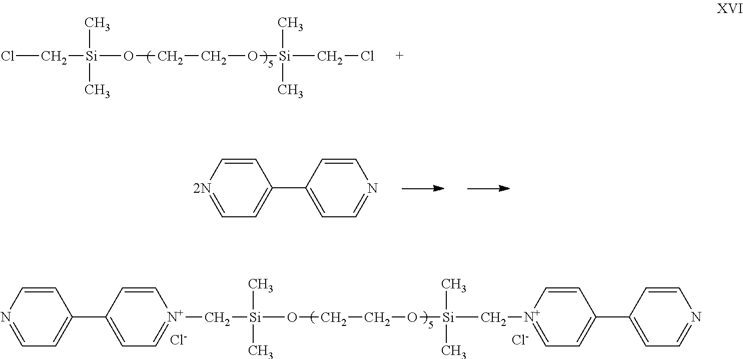

The molecular weight of the reaction product is M=763.91.

These compounds (XVI) have in structure the following group

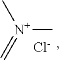

The presence of this group allows to classify this synthesized compound to the class of the salts.

Low molecular weight compounds with such group are called quaternary ammonium salts. The macromolecular (high molecular weight) compounds with such group are called polymeric quaternary ammonium salts.

### Example 2

In this example the description of the synthesis of the macromolecular (high molecular weight) polymer organosilicon quaternary ammonium salt is presented. These types of the salts also are known as organosilicone polyviologen.

### 1 Step.

The first step of the synthesis is similar to the first step in the example 1.

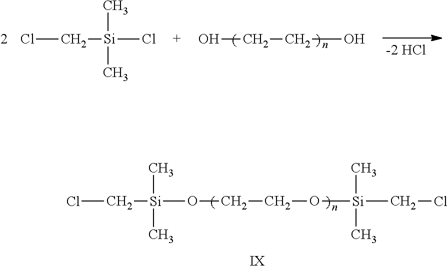

### 2 Step.

During the second step the synthesis was carried out by the following procedure. In the flask with a round bottom the 0.0023 M of the bis(chloromethyl)dimethylsilyl ether pentaethylene glycol a was placed and then 0.0023 M of 4,4′-dipyridyl was added. The mixture of the monomer was heated at 60° C. The formation of a clear solution was observed. Complete dissolution of 4,4′-dipyridyl in the bis(chloromethyl)dimethylsilyl ether pentaethylene glycol IX was considered as the beginning of the reaction. Falling of the light brown precipitate from the reaction mixture during the carry out of the reaction was observed. Duration of the reaction was 6 hours. Precipitated high molecular weight polymer organosilicon quaternary ammonium salt (organosilicone poly viologen) XIX was filtered, washed several times with acetone, and dried under vacuum in the desiccator to constant weight

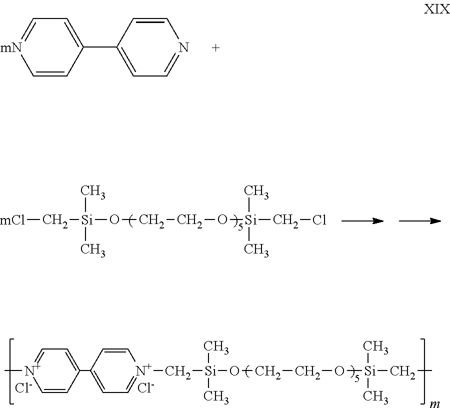

Product of the reaction: the high molecular weight (macromolecular) polymer organosilicon quaternary ammonium salt, XIX

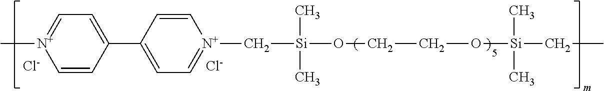

where “m” characterizes the degree of the polymerization

### CLOSURE

While various embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. Nonaqueous electrolyte containing an aprotic solvent, salt of the alkali metal, and composition of the additives that comprises the compounds from the class of esters, low molecular weight silicon quaternary ammonium salts, and macromolecular polymer organosilicon quaternary ammonium salts

2. Nonaqueous electrolyte as set forth in claim 1, wherein the said compound from the class of esters is the crown ethers for 12-crown-4 that corresponds to the formula C8H16O4 and to the molecular weight 176,212.

3. Nonaqueous electrolyte as set forth in claim 1, wherein the said compound from the class of low molecular weight silicon quaternary ammonium salts includes in the structure the following group:

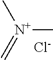

4. Nonaqueous electrolyte as set forth in claim 3, wherein the said compound from the class of low molecular weight silicon quaternary ammonium salts that includes in the structure the following group: 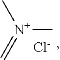
is obtained as a result of interaction bis (chloromethyl) dimethylsilyl ether pentaethylene glycol with 4,4′-dipyridyl

5. Nonaqueous electrolyte as set forth in claim 1, wherein the said compound from the class of macromolecular polymer organosilicon quaternary ammonium salts has the following structure: 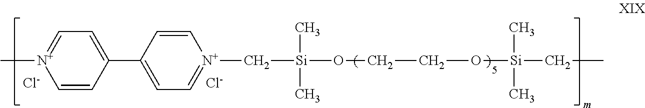
where “m” characterizes the degree of the polymerization.

6. Nonaqueous electrolyte as set forth in claim 1, wherein the said composition of additives comprises the compounds from the class of esters and from the class of low molecular weight silicon quaternary ammonium salts, and the content of compounds from the class of esters in the composition of the additives is from 2 to 98 percent by weight.

7. Nonaqueous electrolyte as set forth in claim 1, wherein the said composition of additives comprises the compounds from the class of esters and from the class of macromolecular polymer organosilicon quaternary ammonium salts, and the content of compounds from the class of esters in the composition of additives is from 2 to 98 percent by weight.

8. Nonaqueous electrolyte as set forth in claim 1, wherein the said content of compounds from the class of esters in the composition of the additives is from 2 to 98 percent by weight, and the ratio between the low molecular weight silicon quaternary ammonium salts and the macromolecular polymer organosilicon quaternary ammonium salts is located in the range of 1:9 to 9:1.

9. Nonaqueous electrolyte as set forth in claim 1, wherein the said total content of additives in the electrolyte ranges from 5×10⁻² mass % up to 1 mass %

10. Nonaqueous electrolyte as set forth in claim 1, wherein the said nonaqueous electrolyte is liquid.

11. Nonaqueous electrolyte as set forth in claim 1, wherein the said nonaqueous electrolyte is polymer.

12. Lithium-ion battery with nonaqueous electrolyte containing an aprotic solvent, salt of the alkali metal, and composition of additives that comprises the compounds from the class of esters, low molecular weight silicon quaternary ammonium salts, and macromolecular polymer organosilicon quaternary ammonium salts; anode based on the compounds that able to intercalate lithium cations, for example, compounds based on carbon, metal oxides and metal sulfides; and cathode based on the compounds from the class of lithiated oxides, sulfides, or fluorine-containing compounds.

13. Lithium battery with nonaqueous electrolyte containing an aprotic solvent, salt of the alkali metal, and composition of the additives that comprises the compounds from the class of esters, low molecular weight silicon quaternary ammonium salts, and macromolecular polymer organosilicon quaternary ammonium salts, anode that is based on the lithium metal or lithium alloys, and cathode based on the chemical compounds which are from the class of oxides, sulfides, or fluorine-containing compounds.
